(19) United States
(12) Patent Application Publication
(10) Pub. No.: US 2018/0047061 A1
(43) Pub. Date: Feb. 15, 2018

(54) SOCIAL MESSAGE PROMOTION ENHANCEMENT

(71) Applicant: INTERNATIONAL BUSINESS MACHINES CORPORATION, Armonk, NY (US)

(72) Inventors: Paul R. Bastide, Boxford, MA (US); Jaime M. Stockton, Acton, MA (US); Brian M. Walsh, Somerville, MA (US)

(21) Appl. No.: 15/234,415

(22) Filed: Aug. 11, 2016

(51) Int. Cl. G06Q 30/02; H04L 29/08; H04L 12/58

(52) U.S. Cl. CPC G06Q 30/0269; H04L 51/32; G06Q 30/0277; H04L 67/22; G06Q 50/01

(57) ABSTRACT

An approach is provided for promoting user-generated content in a social network message list. An intent of a first user of a social networking service to perform an action related to goals of an advertising campaign is identified. Based on the identified intent of the first user, content is selected. The selected content is related to the advertising campaign and was authored by a second user of the social networking service. The second user is a trusted social contact of the first user. A priority of the selected content is increased. Based on the increased priority, the selected content is promoted to and displayed in a topmost position in the social network message list being viewed by the first user.

### BACKGROUND

The present invention relates to social networking systems, and more particularly to managing a social network message list.

Mail clients and online social networks connect users and information in logical and organized ways to enable sharing and processing of information between the users. Common social network features for sharing and processing of the information include the inbox, wall, activity stream, timeline, and profile. These features enable a user to rapidly share information with others and gather information from others in the social network via social network messages. A user may create and receive a significant number of social network messages each day. The user reads and responds to many of the received social network messages, but because of the large number of messages received, some messages in the user's social network message list are missed, ignored, or processed without a useful priority.

With an increasing number of social network messages being sent, the social network message list of a user is valuable onscreen “real estate” which is being monetized with advertising revenue by displaying an advertiser-generated message or post in the user's social network message list in response to detecting a match between word(s) posted by the user and keyword(s) included in a set of keywords associated with an advertising campaign.

### SUMMARY

In a first embodiment, the present invention provides a method of promoting user-generated content in a social network message list. The method includes a computer identifying an intent of a first user of a social networking service to perform an action related to goals of an advertising campaign. The method further includes based on the identified intent of the first user, the computer selecting content that is related to the advertising campaign and that was authored by a second user of the social networking service. The second user is a trusted social contact of the first user in a social network provided by the social networking service. The method further includes the computer increasing a priority of the selected content that was authored by the second user. The method further includes based on the increased priority, the computer promoting the selected content to a topmost position in the social network message list, which results in a display of the social network message list having the content that was authored by the second user included in the topmost position. The display of the social network message list is viewed by the first user.

In a second embodiment, the present invention provides a computer program product including a computer-readable storage medium and a computer-readable program code stored in the computer-readable storage medium. The computer-readable program code includes instructions that are executed by a central processing unit (CPU) of a computer system to implement a method of promoting user-generated content in a social network message list. The method includes the computer system identifying an intent of a first user of a social networking service to perform an action related to goals of an advertising campaign. The method further includes based on the identified intent of the first user, the computer system selecting content that is related to the advertising campaign and that was authored by a second user of the social networking service. The second user is a trusted social contact of the first user in a social network provided by the social networking service. The method further includes the computer system increasing a priority of the selected content that was authored by the second user. The method further includes based on the increased priority, the computer system promoting the selected content to a topmost position in the social network message list, which results in a display of the social network message list having the content that was authored by the second user included in the topmost position. The display of the social network message list is viewed by the first user.

In a third embodiment, the present invention provides a computer system including a central processing unit (CPU); a memory coupled to the CPU; and a computer-readable storage device coupled to the CPU. The storage device includes instructions that are executed by the CPU via the memory to implement a method of promoting user-generated content in a social network message list. The method includes the computer system identifying an intent of a first user of a social networking service to perform an action related to goals of an advertising campaign. The method further includes based on the identified intent of the first user, the computer system selecting content that is related to the advertising campaign and that was authored by a second user of the social networking service. The second user is a trusted social contact of the first user in a social network provided by the social networking service. The method further includes the computer system increasing a priority of the selected content that was authored by the second user. The method further includes based on the increased priority, the computer system promoting the selected content to a topmost position in the social network message list, which results in a display of the social network message list having the content that was authored by the second user included in the topmost position. The display of the social network message list is viewed by the first user.

Embodiments of the present invention increases advertising revenue by selecting relevant user-generated content and promoting the content into a prominent position in a social network message list. The selection and promotion of the user-generated content may be applied to any type of collaborative message, including email, instant messages, project management, activity streams, and collaboration tools used by software development teams.

### BRIEF DESCRIPTION OF THE DRAWINGS

FIG. 1 is a block diagram of a system for promoting user-generated content in a social network message list to provide an advertisement, in accordance with embodiments of the present invention.

FIG. 2 is a flowchart of a process for promoting user-generated content in a social network message list to provide an advertisement, where the process is implemented in the system of FIG. 1, in accordance with embodiments of the present invention.

FIG. 3 is an example of a social network message list in which user-generated content is promoted and provides an advertisement, where the social network message list is displayed after the process of FIG. 2, in accordance with embodiments of the present invention.

FIG. 4 is a block diagram of a computer that is included in the system of FIG. 1 and that implements the process of FIG. 2, in accordance with embodiments of the present invention.

### DETAILED DESCRIPTION

### Overview

Embodiments of the present invention allows an entity (e.g., advertiser) to identify a user's intent to use a product or service, visit a business, attend an event, or engage in an activity otherwise associated with the entity's advertising campaign. Based on the identified user intent, embodiments of the present invention select content authored by a close friend or another trusted social contact of the user, where the content is associated with a goal of the advertising campaign. In one embodiment, the content is selected based on the contact having been previously posted on the user's social network message list. Embodiments of the present invention promotes the selected content by displaying the content in a prominent location in the social network message list (e.g., at the top of the message list). The selected content may be modified to include a notification of the entity's sponsorship of the content and/or the advertising campaign's association with the content. Other modifications to the selected content may add a hyperlink or a graphical control element such as a mouseover to allow display of additional information about the advertising campaign, and may further add features to allow the entity to monitor recommendations and comments associated with the modified content.

Using known techniques, advertiser-generated messages and posts are presented inline to a user's social network message list, but are often ignored by the user because the user has chosen to pay attention only to those messages and posts from close friends or other trusted social contacts. Users ignoring advertiser-generated messages and posts decrease the effectiveness of advertising campaigns, which presents a unique challenge to advertisers. Using embodiments of the present invention, an advertiser can increase the likelihood of a user successfully responding to an advertising campaign by selecting and modifying a message that was previously generated by a close friend of the user, and promoting that message to the top of the user's social network message list. The user is more likely to pay attention to the promoted message and the advertising campaign associated with the promoted message, because the message is from a close friend of the user. The increased attention to the advertising campaign makes the user more likely to perform an action which increases the effectiveness of the advertising campaign (e.g., make an online purchase, visit a location, attend an event, etc.).

### System for Promoting User-Generated Content in a Social Network Message List

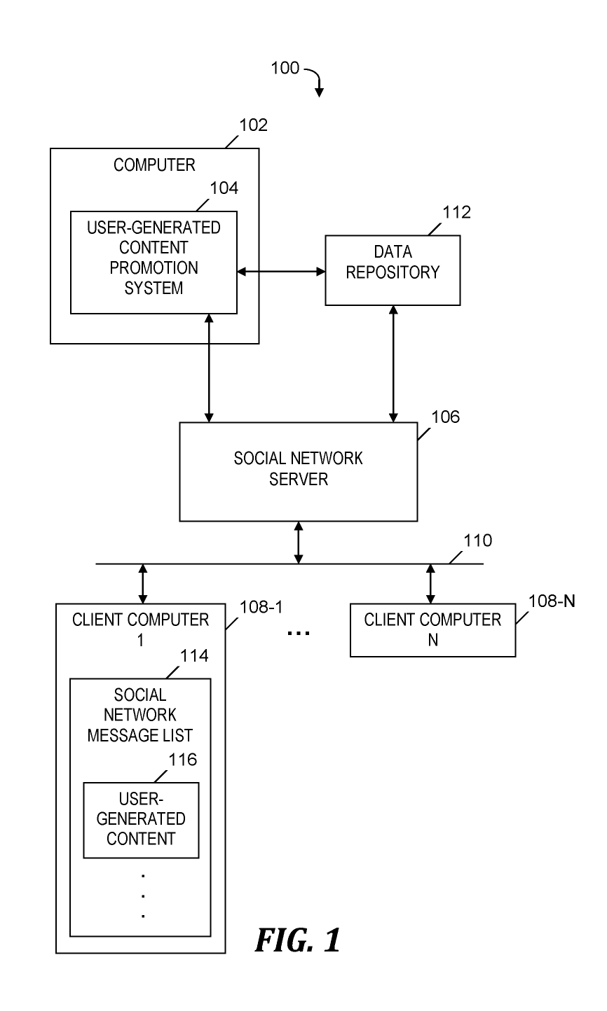

FIG. 1 is a block diagram of a system 100 for promoting user-generated content in a social network message list to provide an advertisement, in accordance with embodiments of the present invention. System 100 includes a computer 102, which executes a software-based user-generated content promotion system 104. System 100 also includes a social network server 106, which provides a social networking service to client computer 108-1, . . . , client computer 108-N via a computer network 110, where N is an integer greater than one.

Social network server 106 stores social network data in a data repository 112. The social network data includes social network messages, recommendations, and other content that is authored by users of client computers 108-1, . . . , 108-N and posted via the social networking service provided by social network server 106. The social network data also includes profile information for each user of the social networking service, where the profile information specifies the other users of the social networking service who are close friends or other trusted social contacts of each user.

User-generated content promotion system 104 receives a specification of goals of an advertising campaign of a business or organization and stores the specification of the goals in data repository 112. User-generated content promotion system 104 accesses and analyzes the social network data stored in data repository 112 to identify an intent of a user of client computer 108-1 to engage in an activity related to the goals of the advertising campaign (e.g., use a product or a service, visit a location, attend an event, etc.).

User-generated content promotion system 104 searches for and accesses content in data repository 112 that (1) was authored by the trusted social contacts of the user who has the intent to engage in the activity related to the advertising campaign's goals, and (2) includes one or more words or phrases that match one or more key words or phrases associated with the advertising campaign. In one embodiment, user-generated content promotion system 104 searches for the aforementioned content based in part on the content having been previously posted in a social network message list 114 provided to the user.

User-generated content promotion system 104 increases the priority of the aforementioned content authored by the user's close friend or other trusted social contact so that client computer 108-1 displays the content as user-generated content 116 in a prominent position in social network message list 114 for viewing by the user.

User-generated content promotion system 104 may modify user-generated content 116 to display additional information or hyperlink(s) related to the advertising campaign (e.g., a notice indicating the name of the organization sponsoring the advertising campaign or a hyperlink to the website of the organization sponsoring the advertising campaign). User-generated content promotion system 104 may modify user-generated content 116 by adding graphical control element(s) or another feature to the content which allows an entity associated with the advertising campaign to monitor the effectiveness of the advertising campaign.

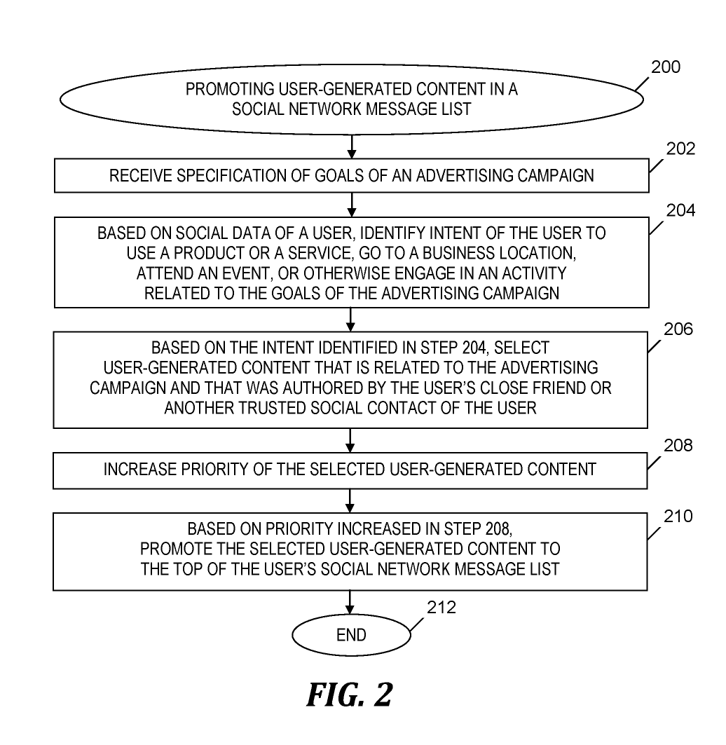

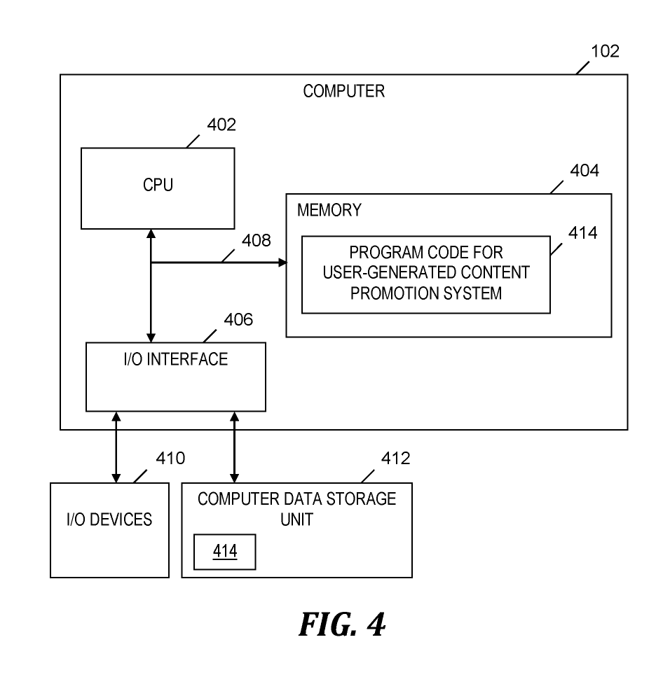

The functionality of the components shown in FIG. 1 is described in more detail in the discussion of FIG. 2 and FIG. 4 presented below.

### Process for Promoting User-Generated Content in a Social Network Message List

FIG. 2 is a flowchart of a process for promoting user-generated content in a social network message list to provide an advertisement, where the process is implemented in the system of FIG. 1, in accordance with embodiments of the present invention. The process of FIG. 2 starts at step 200. In step 202, user-generated content promotion system 104 (see FIG. 1) receives a specification of goals of an advertising campaign. For example, user-generated content promotion system 104 (see FIG. 1) receives a specification of a goal from City X Office of Tourism, where the goal is to increase tourism to City X.

In one embodiment, step 202 includes user-generated content promotion system 104 (see FIG. 1) receiving and storing a product description for a product being promoted by the advertising campaign, and an object description that best represents the product (e.g., tag, hashtag, or comment).

In one embodiment, step 202 includes user-generated content promotion system 104 (see FIG. 1) receiving and storing a number of attributions (i.e., user events specified by a marketing attribution model), click-throughs, page-views, or online purchases, or a combination thereof, that indicate that the advertising campaign is effective. The goals of the advertising campaign may specify an increase in product purchases, click-throughs, page-views, and an expected attribution.

In step 204, based on social data of a user of client computer 108-1 (see FIG. 1), user-generated content promotion system 104 (see FIG. 1) identifies an intent of the user to use or purchase a product or service, visit a location of a business or another organization, visit a country, city or other place, attend an event, or otherwise engage in an activity related to the aforementioned goals of the advertising campaign. Hereinafter in the discussion of FIG. 2, the aforementioned user of client computer 108-1 (see FIG. 1) is referred to as “the user.”

In one embodiment, user-generated content promotion system 104 (see FIG. 1) identifies the intent of the user by determining that word(s) used in content authored by the user via the social networking service match or map to respective key word(s) associated with the advertising campaign. Prior to step 204, user-generated content promotion system 104 (see FIG. 1) receives the key words associated with the advertising campaign and a mapping of key words to respective words that may appear in user-generated content. In one embodiment, user-generated content promotion system 104 (see FIG. 1) retrieves the aforementioned key words and mapping from data repository 112 (see FIG. 1).

In one embodiment, prior to step 204, user-generated content promotion system 104 (see FIG. 1) receives a specified time period, where selecting the content in step 206 (as discussed below) includes selecting only content that was authored by a close friend or another trusted social contact of the user within the specified time period. For example, the received specified time period is twelve months and the user-generated content is selected only from content authored within the preceding twelve months.

Prior to step 206, user-generated content promotion system 104 (see FIG. 1) determines users of the social networking service who are close friends or are other trusted social contacts of the user.

In step 206, based on the intent identified in step 204, user-generated content promotion system 104 (see FIG. 1) selects user-generated content 116 (see FIG. 1) from content stored in data repository 112 (see FIG. 1), where the content was authored by a close friend or another trusted social contact of the user and includes content that is related to the advertising campaign. In one embodiment, the user-generated content 116 (see FIG. 1) is selected in step 206 based in part on the user-generated content 116 (see FIG. 1) having been previously displayed in the social network message list 114 (see FIG. 1) of the user. The selected user-generated content 116 (see FIG. 1) was not authored for the advertising campaign.

In one embodiment, user-generated content promotion system 104 (see FIG. 1) determines that content is related to the advertising campaign by identifying a match between one or more words in the user-generated content 116 (see FIG. 1) and one or more key words included in a plurality of key words associated with the advertising campaign. Prior to step 206, user-generated content promotion system 104 (see FIG. 1) receives the plurality of key words associated with the advertising campaign.

In one embodiment, user-generated content promotion system 104 (see FIG. 1) selects the user-generated content 116 (see FIG. 1) in step 206 based in part on the user-generated content 116 (see FIG. 1) expressing a positive sentiment about someone or something being promoted by the advertising campaign (or expressing a negative sentiment which relates to the goals of the advertising campaign) and including word(s) that match respective word(s) included in the social data which was the basis of identifying the intent of the user in step 204. User-generated content promotion system 104 (see FIG. 1) receives a specification of the aforementioned sentiment prior to step 206.

In one embodiment, user-generated content promotion system 104 (see FIG. 1) selects the user-generated content 116 (see FIG. 1) in step 206 based in part on a number of likes and recommendations that are received by the user-generated content 116 (see FIG. 1).

In step 208, user-generated content promotion system 104 (see FIG. 1) increases a priority of the user-generated content 116 (see FIG. 1) selected in step 206 (i.e., increases a weight of the importance of the user-generated content). Priorities are quantities corresponding to respective content items (e.g., messages), where the content items are displayed in an order in social network message list 114 (see FIG. 1) which matches the order of the corresponding priorities. For example, the content having the greatest priority is displayed at the highest position (i.e., top) of social network message list 114 (see FIG. 1).

In an alternate embodiment, in another step (not shown) subsequent to step 206 and prior to step 210, user-generated content promotion system 104 (see FIG. 1) modifies user-generated content 116 (see FIG. 1) to include and display additional information and/or hyperlink(s) related to the advertising campaign. The modification to user-generated content 116 (see FIG. 1) may include adding a graphical control element such as a mouseover, which when activated displays the additional information related to the advertising campaign. For example, activating a mouseover element added to user-generated content 116 (see FIG. 1) displays text identifying the name of the entity sponsoring the advertising campaign.

In one embodiment, when one of the aforementioned hyperlink(s) is activated by the user utilizing a web browser, the web browser navigates to a website of an entity sponsoring or otherwise associated with the advertising campaign.

In an alternate embodiment, in the other step (not shown) subsequent to step 206 and prior to step 210 user-generated content promotion system 104 (see FIG. 1) modifies user-generated content 116 to include features that allow an entity associated with the advertising campaign to monitor the effectiveness of the advertising campaign. For example, user-generated content promotion system 104 (see FIG. 1) allows an entity associated with the advertising campaign to monitor the recommendations that the user provided which are related to the goals of the advertising campaign or the number of click-through actions taken by the user to visit a website associated with the goals of the advertising campaign.

In one embodiment, the user-generated content selected in step 206 is based on the cost or potential payout if the user engages in the activity related to the goals of the advertising campaign.

In step 210, based on the priority increased in step 208, user-generated content promotion system 104 (see FIG. 1) promotes the user-generated content 116 (see FIG. 1) to the top of (or another prominent position in) social network message list 114 (see FIG. 1). Client computer 108-1 (see FIG. 1) displays the user-generated content 116 (see FIG. 1) at the top of (or in another prominent position in) social network message list 114 (see FIG. 1). The process of FIG. 2 ends at step 212.

In one embodiment, after step 210, an entity associated the advertising campaign monitors actions taken by the user related to the goals of the advertising campaign, including the user interacting with a graphical control element added to user-generated content 116 (see FIG. 1) in another step (not shown) subsequent to step 206 and prior to step 210. The interaction with the graphical control element results in an online purchase, a click-through, a page view, or a user event specified by a marketing attribution model. Other users may view the same user-generated content 116 (see FIG. 1) modified in the other step (not shown) subsequent to step 206 and prior to step 210 and the user-generated content promotion system 104 (see FIG. 1) monitors the aforementioned actions taken by the other users. Based in part on the monitored actions taken by the user and the other users, user-generated content promotion system 104 (see FIG. 1) determines whether the goals of the advertising campaign are satisfied.

In an alternate embodiment, step 206 selects multiple messages from a trusted social contact of the user, where each message include word(s) that match key word(s) associated with the advertising campaign, step 206 selects only one of the identified multiple messages, another step (not shown) subsequent to step 206 and prior to step 210 modifies the one selected message, and step 210 promotes the one selected and modified message so that the user and one or more other users who are connected to the trusted social contact via the social networking service view corresponding social network message lists that each have the selected and modified message in a prominent position (e.g., at the top of the list).

In an alternate embodiment, step 206 selects N messages from a plurality of messages authored by N trusted social contacts of the user, where the N trusted social contacts are connected via the social networking service to each other and to the same group of people, and where N is an integer greater than one. In the other step (not shown) subsequent to step 206 and prior to step 210, user-generated content promotion system 104 (see FIG. 1) applies to each of the N messages the aforementioned modification to the user-generated content 116 (see FIG. 1) to include and display additional information and/or hyperlink(s) related to the advertising campaign. In step 210, user-generated content promotion system 104 (see FIG. 1) promotes the N messages so that a social network message list displayed to each person in the aforementioned group of people includes the N messages displayed in prominent positions in the list.

In one embodiment, after step 210, client computer 108-1 (see FIG. 1) displays social network message list 114 (see FIG. 1) so that the instances of content are in a chronological order based on the time at which the instances of content are posted in social network message list 114 (see FIG. 1), except that the user-generated content 116 (see FIG. 1) is displayed out of chronological order based on the increase in its priority in step 208.

In an alternate embodiment, in which another step (not shown) performed subsequent to step 206 and prior to step 210 includes user-generated content promotion system 104 (see FIG. 1) modifying user-generated content 116 (see FIG. 1) to include and display additional information about the advertising campaign, step 210 results in a display of social network message list 114 (see FIG. 1) having the modified user-selected content 116 (see FIG. 1) together with the additional information about the advertising campaign.ee FIG. 1) included in a topmost position (or in another prominent position) in social network message list 114 (see FIG. 1).

In another alternate embodiment, the intent identified in step 204 may be identified by determining the geolocation of the user based on the user's calendar or travel receipts. For example, because the user's calendar indicates that the user is in City X, user-generated content promotion system 104 (see FIG. 1) selects the user-generated content in step 206 based on the user-generated content including word(s) that name City X or are otherwise related to City X.

In one embodiment, user-generated content promotion system 104 (see FIG. 1) transfers a monetary reward or other reward to the close friend or other trusted social contact of the user whose content was selected in step 206 and promoted in step 212.

In one embodiment, user-generated content promotion system 104 (see FIG. 1) may provide a pay-per-click system based on the number of likes or recommendations previously received by user-generated content 116 (see FIG. 1) prior to its modification in another step (not shown) performed subsequent to step 206 and prior to step 210.

### EXAMPLE

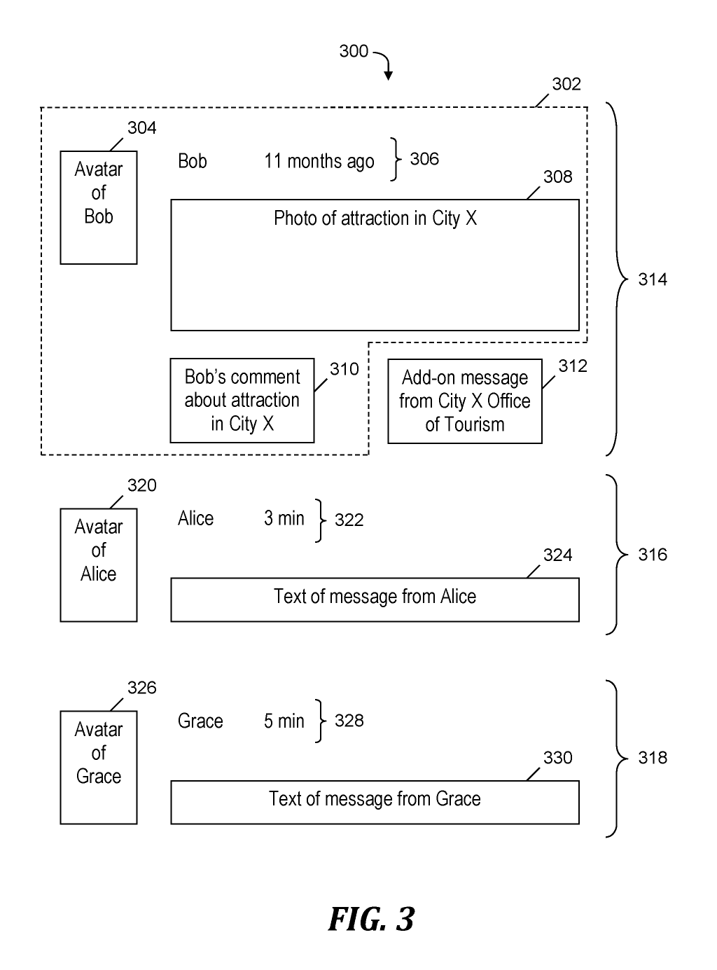

FIG. 3 is an example of a social network message list 300 in which user-generated content is promoted and provides an advertisement, where the social network message list is displayed after the process of FIG. 2, in accordance with embodiments of the present invention. In the process of FIG. 2, goals of an advertising campaign of City X Office of Tourism include increasing tourist visits to City X. In step 202 (see FIG. 2), the goals of the advertising campaign of City X Office of Tourism are received by user-generated content promotion system 104 (see FIG. 1). In step 204 (see FIG. 2), user-generated content promotion system 104 (see FIG. 1) retrieves social data of Chris from data repository 112 (see FIG. 1) which includes text authored by Chris which indicates that Chris has an interest in visiting a region of the country that includes City X and includes a photo posted by Chris, where the photo includes an attraction in City X.

Based on the identified intent of Chris to visit the region that includes City X, user-generated content promotion system 104 (see FIG. 1) searches for one or more messages that were previously posted in the social network message list 300 of Chris within the previous twelve months, were authored by close friends or other trusted social contacts of Chris, and include content that (1) matches the name of City X and/or other words related to City X and (2) expresses a positive sentiment about City X. In step 206 (see FIG. 2), based on the aforementioned search, user-generated content promotion system 104 (see FIG. 1) finds a message 302 from Bob, who is a close friend of Chris, where the message from Bob was originally posted in social network message list 300 eleven months ago. Message 302 from Bob includes an avatar 304 of Bob and a heading 306 that identifies Bob as the author of message 302 and the amount of time between the time of the original posting of message 302 and the current time. Message 302 from Bob also includes a photo 308 of an attraction in City X and a comment 310 authored by Bob that expresses a positive sentiment about the attraction in City X which is depicted in photo 308.

User-generated content promotion system 104 (see FIG. 1) increases the priority of the message from Bob in step 208 (see FIG. 2). In step 210 (see FIG. 2), user-generated content promotion system 104 (see FIG. 1) modifies the message from Bob by inserting an add-on message 312 from City X Office of Tourism, which generates a modified message 314 from Bob. Add-on message 312 includes the text “Sponsored by City X Office of Tourism” and a hyperlink (not shown) to a website of the City X Office of Tourism. The add-on message 312 was not included in the original message 302 from Bob which was posted in social network message list 300 eleven months ago.

Based on the increased priority of message 302, user-generated content promotion system 104 (see FIG. 1) promotes modified message 314 so that modified message 314 is displayed at the top of social network message list 300, which also includes chronologically ordered message postings 316 and 318 displayed below modified message 314. The modified message 314 is not displayed in the aforementioned chronological order. Based on Bob being a trusted social contact of Chris, the social network message list 300 having modified message 314 from Bob at the top of the list encourages Chris to take action in accordance with the goals of the advertising campaign by visiting City X.

Message posting 316 includes an avatar 320 of Alice, a heading 322 identifying Alice as the author of the message in posting 316 and “3 min” as the amount of time (i.e., 3 minutes) between the time of the original posting of the message and the current time. Message posting 316 also includes text of a message 324 authored by Alice.

Message posting 318 includes an avatar 326 of Grace, a heading 328 identifying Grace as the author of the message in posting 318 and “5 min” as the amount of time (i.e., 5 minutes) between the time of the original posting of the message and the current time. Message posting 318 also includes text of a message 330 authored by Grace.

By inserting add-on message 312 to generate modified message 314, user-generated content promotion system 104 (see FIG. 1) includes a feature that allows City X Office of Tourism or another entity to monitor the number of times Bob clicks on the hyperlink included in add-on message 312, thereby providing data to City X Office of Tourism to determine whether the advertising campaign is effective.

### Computer System

FIG. 4 is a block diagram of a computer that is included in the system of FIG. 1 and that implements the process of FIG. 2, in accordance with embodiments of the present invention. Computer 102 is a computer system that generally includes a central processing unit (CPU) 402, a memory 404, an input/output (I/O) interface 406, and a bus 408. Computer 102 is coupled to I/O devices 410 and a computer data storage unit 412. CPU 402 performs computation and control functions of computer 102, including executing instructions included in program code 414 for user-generated content promotion system 104 (see FIG. 1) to perform a method of promoting user-generated content in a social network message list, where the instructions are executed by CPU 402 via memory 404. CPU 402 may include a single processing unit, or be distributed across one or more processing units in one or more locations (e.g., on a client and server).

Memory 404 includes a known computer readable storage medium, which is described below. In one embodiment, cache memory elements of memory 404 provide temporary storage of at least some program code (e.g., program code 414) in order to reduce the number of times code must be retrieved from bulk storage while instructions of the program code are executed. Moreover, similar to CPU 402, memory 404 may reside at a single physical location, including one or more types of data storage, or be distributed across a plurality of physical systems in various forms. Further, memory 404 can include data distributed across, for example, a local area network (LAN) or a wide area network (WAN).

I/O interface 406 includes any system for exchanging information to or from an external source. I/O devices 410 include any known type of external device, including a display device, keyboard, etc. Bus 408 provides a communication link between each of the components in computer 102, and may include any type of transmission link, including electrical, optical, wireless, etc.

I/O interface 406 also allows computer 102 to store information (e.g., data or program instructions such as program code 414) on and retrieve the information from computer data storage unit 412 or another computer data storage unit (not shown). Computer data storage unit 412 includes a known computer-readable storage medium, which is described below. In one embodiment, computer data storage unit 412 is a non-volatile data storage device, such as a magnetic disk drive (i.e., hard disk drive) or an optical disc drive (e.g., a CD-ROM drive which receives a CD-ROM disk).

Memory 404 and/or storage unit 412 may store computer program code 414 that includes instructions that are executed by CPU 402 via memory 404 to promote user-generated content in a social network message list. Although FIG. 4 depicts memory 404 as including program code 414, the present invention contemplates embodiments in which memory 404 does not include all of code 414 simultaneously, but instead at one time includes only a portion of code 414.

Further, memory 404 may include an operating system (not shown) and may include other systems not shown in FIG. 4.

Storage unit 412 may store social data about users of client computers 108-1, . . . , 108-N (see FIG. 1) and a specification of goals of an advertising campaign.

As will be appreciated by one skilled in the art, in a first embodiment, the present invention may be a method; in a second embodiment, the present invention may be a system; and in a third embodiment, the present invention may be a computer program product.

Any of the components of an embodiment of the present invention can be deployed, managed, serviced, etc. by a service provider that offers to deploy or integrate computing infrastructure with respect to promoting user-generated content in a social network message list. Thus, an embodiment of the present invention discloses a process for supporting computer infrastructure, where the process includes providing at least one support service for at least one of integrating, hosting, maintaining and deploying computer-readable code (e.g., program code 414) in a computer system (e.g., computer 102) including one or more processors (e.g., CPU 402), wherein the processor(s) carry out instructions contained in the code causing the computer system to promote user-generated content in a social network message list. Another embodiment discloses a process for supporting computer infrastructure, where the process includes integrating computer-readable program code into a computer system including a processor. The step of integrating includes storing the program code in a computer-readable storage device of the computer system through use of the processor. The program code, upon being executed by the processor, implements a method of promoting user-generated content in a social network message list.

While it is understood that program code 414 for promoting user-generated content in a social network message list may be deployed by manually loading directly in client, server and proxy computers (not shown) via loading a computer-readable storage medium (e.g., computer data storage unit 412), program code 414 may also be automatically or semi-automatically deployed into computer 102 by sending program code 414 to a central server or a group of central servers. Program code 414 is then downloaded into client computers (e.g., computer 102) that will execute program code 414. Alternatively, program code 414 is sent directly to the client computer via e-mail. Program code 414 is then either detached to a directory on the client computer or loaded into a directory on the client computer by a button on the e-mail that executes a program that detaches program code 414 into a directory. Another alternative is to send program code 414 directly to a directory on the client computer hard drive. In a case in which there are proxy servers, the process selects the proxy server code, determines on which computers to place the proxy servers' code, transmits the proxy server code, and then installs the proxy server code on the proxy computer. Program code 414 is transmitted to the proxy server and then it is stored on the proxy server.

Another embodiment of the invention provides a method that performs the process steps on a subscription, advertising and/or fee basis. That is, a service provider, such as a Solution Integrator, can offer to create, maintain, support, etc. a process of promoting user-generated content in a social network message list. In this case, the service provider can create, maintain, support, etc. a computer infrastructure that performs the process steps for one or more customers. In return, the service provider can receive payment from the customer(s) under a subscription and/or fee agreement, and/or the service provider can receive payment from the sale of advertising content to one or more third parties.

The present invention may be a system, a method, and/or a computer program product. The computer program product may include a computer readable storage medium (or media) (memory 404 and computer data storage unit 412) having computer readable program instructions 414 thereon for causing a processor (e.g., CPU 402) to carry out aspects of the present invention.

The computer readable storage medium can be a tangible device that can retain and store instructions (e.g., program code 414) for use by an instruction execution device (e.g., computer 102). The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions (e.g., program code 414) described herein can be downloaded to respective computing/processing devices (e.g., computer 102) from a computer readable storage medium or to an external computer or external storage device (e.g., computer data storage unit 412) via a network (not shown), for example, the Internet, a local area network, a wide area network and/or a wireless network. The network may comprise copper transmission cables, optical transmission fibers, wireless transmission, routers, firewalls, switches, gateway computers and/or edge servers. A network adapter card (not shown) or network interface (not shown) in each computing/processing device receives computer readable program instructions from the network and forwards the computer readable program instructions for storage in a computer readable storage medium within the respective computing/processing device.

Computer readable program instructions (e.g., program code 414) for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations (e.g., FIG. 2) and/or block diagrams (e.g., FIG. 1 and FIG. 4) of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions (e.g., program code 414).

These computer readable program instructions may be provided to a processor (e.g., CPU 402) of a general purpose computer, special purpose computer, or other programmable data processing apparatus (e.g., computer 102) to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium (e.g., computer data storage unit 412) that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions (e.g., program code 414) may also be loaded onto a computer (e.g. computer 102), other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method of promoting user-generated content in a social network message list, the method comprising the steps of:
a computer identifying an intent of a first user of a social networking service to perform an action related to goals of an advertising campaign;
based on the identified intent of the first user, the computer selecting content that is related to the advertising campaign and that was authored by a second user of the social networking service who is a trusted social contact of the first user in a social network provided by the social networking service;
the computer increasing a priority of the selected content that was authored by the second user; and
based on the increased priority, the computer promoting the selected content to a topmost position in the social network message list, which results in a display of the social network message list having the content that was authored by the second user included in the topmost position, the display of the social network message list being viewed by the first user.

2. The method of claim 1, further comprising the step of the computer modifying the selected content that was authored by the second user so that the modified selected content includes additional information about the advertising campaign, wherein the step of promoting the selected content to the topmost position in the social network message list further results in the display of the social network message list including the additional information about the advertising campaign together with the content that was authored by the second user.

3. The method of claim 1, further comprising the step of the computer determining that a message authored by the second user was previously displayed in the social network message list of the first user, wherein the step of selecting the content includes selecting the message authored by the second user based in part on the message having been previously displayed in the social network message list of the first user, and wherein the selected content includes the selected message.

4. The method of claim 1, further comprising the steps of:
the computer monitoring the action taken by the first user, the action being initiated by an interaction by the first user with a graphical control element, wherein the action is selected from the group consisting of an online purchase, a click-through, a page view, and a user event specified by a marketing attribution model, and wherein the step of modifying the selected content includes adding the graphical control element to the selected content;
the computer monitoring the action taken by other users of the social networking service; and
based on the monitored action taken by the first user and other users, the computer determining whether the goals of the advertising campaign are satisfied.

5. The method of claim 1, further comprising the step of the computer receiving a specified time period, wherein the step of selecting the content includes selecting only content that was authored by the second user within the specified time period.

6. The method of claim 1, further comprising the steps of:
the computer receiving key words associated with the advertising campaign;
the computer determining the second user is the trusted social contact of the first user; and
in response to the steps of receiving the key words and determining the second user is the trusted social contact, the computer identifying a match between one or more words in a message authored by the second user and one or more of the key words, wherein the step of selecting the content includes selecting the message authored by the second user based on the identified match between the one or more words in the message and the one or more of the key words.

7. The method of claim 1, further comprising the step of the computer receiving a specification of a sentiment, wherein the step of selecting the content includes selecting only content that was authored by the second user and that has the sentiment included in the received specification.

8. The method of claim 1, further comprising the step of:
providing at least one support service for at least one of creating, integrating, hosting, maintaining, and deploying computer-readable program code in the computer, the program code being executed by a processor of the computer to implement the steps of identifying the intent, selecting the content, increasing the priority, and promoting the selected content.

9. A computer program product, comprising:
a computer-readable storage medium; and
a computer-readable program code stored in the computer-readable storage medium, the computer-readable program code containing instructions that are executed by a central processing unit (CPU) of a computer system to implement a method of promoting user-generated content in a social network message list, the method comprising the steps of:
the computer system identifying an intent of a first user of a social networking service to perform an action related to goals of an advertising campaign;
based on the identified intent of the first user, the computer system selecting content that is related to the advertising campaign and that was authored by a second user of the social networking service who is a trusted social contact of the first user in a social network provided by the social networking service;
the computer system increasing a priority of the selected content that was authored by the second user; and
based on the increased priority, the computer system promoting the selected content to a topmost position in the social network message list, which results in a display of the social network message list having the content that was authored by the second user included in the topmost position, the display of the social network message list being viewed by the first user.

10. The computer program product of claim 9, wherein the method further comprises the step of the computer system modifying the selected content that was authored by the second user so that the modified selected content includes additional information about the advertising campaign, wherein the step of promoting the selected content to the topmost position in the social network message list further results in the display of the social network message list including the additional information about the advertising campaign together with the content that was authored by the second user.

11. The computer program product of claim 9, wherein the method further comprises the step of the computer system determining that a message authored by the second user was previously displayed in the social network message list of the first user, wherein the step of selecting the content includes selecting the message authored by the second user based in part on the message having been previously displayed in the social network message list of the first user, and wherein the selected content includes the selected message.

12. The computer program product of claim 9, wherein the method further comprises the steps of:
the computer system monitoring the action taken by the first user, the action being initiated by an interaction by the first user with a graphical control element, wherein the action is selected from the group consisting of an online purchase, a click-through, a page view, and a user event specified by a marketing attribution model, and wherein the step of modifying the selected content includes adding the graphical control element to the selected content;
the computer system monitoring the action taken by other users of the social networking service; and
based on the monitored action taken by the first user and other users, the computer system determining whether the goals of the advertising campaign are satisfied.

13. The computer program product of claim 9, wherein the method further comprises the step of the computer system receiving a specified time period, wherein the step of selecting the content includes selecting only content that was authored by the second user within the specified time period.

14. The computer program product of claim 9, wherein the method further comprises the steps of:
the computer system receiving key words associated with the advertising campaign;
the computer system determining the second user is the trusted social contact of the first user; and
in response to the steps of receiving the key words and determining the second user is the trusted social contact, the computer system identifying a match between one or more words in a message authored by the second user and one or more of the key words, wherein the step of selecting the content includes selecting the message authored by the second user based on the identified match between the one or more words in the message and the one or more of the key words.

15. A computer system comprising:
a central processing unit (CPU);
a memory coupled to the CPU; and
a computer-readable storage device coupled to the CPU, the storage device containing instructions that are executed by the CPU via the memory to implement a method of promoting user-generated content in a social network message list, the method comprising the steps of:
the computer system identifying an intent of a first user of a social networking service to perform an action related to goals of an advertising campaign;
based on the identified intent of the first user, the computer system selecting content that is related to the advertising campaign and that was authored by a second user of the social networking service who is a trusted social contact of the first user in a social network provided by the social networking service;
the computer system increasing a priority of the selected content that was authored by the second user; and
based on the increased priority, the computer system promoting the selected content to a topmost position in the social network message list, which results in a display of the social network message list having the content that was authored by the second user included in the topmost position, the display of the social network message list being viewed by the first user.

16. The computer system of claim 15, wherein the method further comprises the step of the computer system modifying the selected content that was authored by the second user so that the modified selected content includes additional information about the advertising campaign, wherein the step of promoting the selected content to the topmost position in the social network message list further results in the display of the social network message list including the additional information about the advertising campaign together with the content that was authored by the second user.

17. The computer system of claim 15, wherein the method further comprises the step of the computer system determining that a message authored by the second user was previously displayed in the social network message list of the first user, wherein the step of selecting the content includes selecting the message authored by the second user based in part on the message having been previously displayed in the social network message list of the first user, and wherein the selected content includes the selected message.

18. The computer system of claim 15, wherein the method further comprises the steps of:
the computer system monitoring the action taken by the first user, the action being initiated by an interaction by the first user with a graphical control element, wherein the action is selected from the group consisting of an online purchase, a click-through, a page view, and a user event specified by a marketing attribution model, and wherein the step of modifying the selected content includes adding the graphical control element to the selected content;
the computer system monitoring the action taken by other users of the social networking service; and
based on the monitored action taken by the first user and other users, the computer system determining whether the goals of the advertising campaign are satisfied.

19. The computer system of claim 15, wherein the method further comprises the step of the computer system receiving a specified time period, wherein the step of selecting the content includes selecting only content that was authored by the second user within the specified time period.

20. The computer system of claim 15, wherein the method further comprises the steps of:
the computer system receiving key words associated with the advertising campaign;
the computer system determining the second user is the trusted social contact of the first user; and
in response to the steps of receiving the key words and determining the second user is the trusted social contact, the computer system identifying a match between one or more words in a message authored by the second user and one or more of the key words, wherein the step of selecting the content includes selecting the message authored by the second user based on the identified match between the one or more words in the message and the one or more of the key words.
